(19) United States
(12) Patent Application Publication
(10) Pub. No.: US 2025/0123477 A1
(43) Pub. Date: Apr. 17, 2025

(54) DISPLAY OVERLAY SYSTEM

(71) Applicant: Sheltered Wings, Inc. d/b/a Vortex Optics, Barneveld, WI (US)

(72) Inventors: Christian Benson, Barneveld, WI (US); Will Lowry, Barneveld, WI (US); Ben Farrell, Barneveld, WI (US); Alec Collins, Barneveld, WI (US)

(21) Appl. No.: 18/667,492

(22) Filed: May 17, 2024

Related U.S. Application Data
(60) Provisional application No. 63/502,880, filed on May 17, 2023.

(51) Int. Cl. G02B 23/04; F41G 1/38

(52) U.S. Cl. CPC G02B 23/04; F41G 1/38

(57) ABSTRACT

A display system for overlaying an image in a field of view of a view-through optic. The display system includes a relay optic having a prism and a beam combiner. The display system also includes a mounting system that includes a display holder that is adjustable in three degrees of freedom.

### CROSS-REFERENCE TO RELATED APPLICATIONS

This application claims priority to and is a non-provisional patent application of U.S. Provisional Patent Application No. 63/502,880 filed May 17, 2023, which is incorporated herein by reference in its entirety.

### FIELD

This disclosure relates generally to viewing optics. In particular, this disclosure relates to an optical system that allows for a display to be viewable through an optical path of a view-through optic.

### BACKGROUND

View-through optics used in the sporting industry, such as riflescopes, binoculars, spotting scopes, etc, can be improved by projecting information to the user's eye overlayed on the field of view. One typical way to accomplish this is through the use of a beam combiner that is in the optical path coupled with a display that is outside of the optical path. To align the focal plane of the display and the optical image, it is common that optics include an axial adjustment. Existing solutions can only achieve best focus of only a portion of the display because the display takes up a large portion of the optical aperture. This leads to aberrations and defocusing at the edges of the projected displayed information. Existing relay optical designs are relatively large and are difficult and expensive to assemble. They also leave less opportunity to utilize highly corrective optical surfaces like off-axis, freeform, or aspheric.

In certain existing solutions, information displayed outside the optical path travels into a beam combiner or mirror located within the optical path. The beam combiner or mirror overlays the displayed information onto the field of view of a view-through optic. Certain relay optical designs include the beam combiner or mirror and all optical elements preceding it (if any) tracing back to the information outside the view-through optical path. Relay optical designs may include a single beam combiner or mirror or may include additional optical elements.

There are three primary optical functions required for an optical design when taking information shown on a display and relaying it into a view-through optical path (relay optical design). These are magnification, aberration control, and beam control.

This disclosure relates to an improved relay optic design that replaces traditional mirror/lens arrangements with prism/integrated elements.

This disclosure also includes a mounting system for the display that adds additional degrees of freedom to adjust the display for the purpose of better control of the focus of the displayed image. This also allows for misalignment to be corrected through adjustment of the fixture instead of relying on manufacturing tolerances to position the display correctly.

### SUMMARY

In one embodiment, the disclosure provides a display system for overlaying an image in a field of view of a view-through optic. The display system includes a display—such as a micro pixel display—positioned outside of the field of view of the view-through optic and a relay optic. The replay optic includes a prism element having a plurality of optical surfaces, wherein the prism element directs light produced by the display and a beam combiner, wherein the beam combiner causes light produced by the display that passes through the prism element to be overlayed in the field of view of the view-through optic.

In one embodiment, the disclosure relates to a display system for overlaying an image in a field of view of a view-through optic, the display system comprising: a display positioned outside of the field of view of the view-through optic; a relay optic comprising: a prism element having a plurality of optical surfaces, wherein the prism element directs light produced by the display; and a beam combiner, wherein the beam combiner causes light produced by the display to be overlayed in the field of view of the view-through optic.

In one embodiment, the prism element integrates magnification, beam control, and aberration control. In another embodiment, the prism element includes three optical surfaces.

In one embodiment, the prism element includes five optical surfaces.

In one embodiment, the display is a micro pixel display.

In one embodiment, the disclosure relates to a viewing optic comprising: a body with a first end and a second end and having a center axis; an objective lens system disposed within the body; an eyepiece lens system disposed within the body; an erector lens system disposed within the body; the objective lens system, eyepiece lens system, and erector lens system forming an optical system having a first focal plane, the first focal plane proximate the objective lens system and a second focal plane proximate the eyepiece; and a display system, the display system comprising: a display positioned outside a field of view of the viewing optic; and a beam combiner having a plurality of optical surfaces, the beam combiner configured to integrate magnification, beam control, and aberration control, wherein the beam combiner causes light produced by the display to be overlayed in the field of view of the view-through optic.

In one embodiment, the beam combiner includes three optical surfaces. In another embodiment, the beam combiner includes five optical surfaces.

In one embodiment, the disclosure relates to a mounting system comprising; a holder; a display attached to the holder; the holder attached to a mounting assembly by a plurality of screws, each of the screws including a screw head; at least one biasing member positioned between the mounting assembly and the holder, the at least one biasing member configured to bias the holder toward the screw heads of the plurality of screws; and the plurality of screws positioned such that tightening or loosening the screws causes the position of the holder to move relative to the mounting assembly.

In one embodiment, the disclosure provides a mounting system for mounting a display outside the field of view of a view-through optic. A display is attached to the holder which, in turn, is attached to a mounting assembly. The holder is attached to the mounting assembly by a plurality of screws, each of which includes a screw head. At least one biasing member is positioned between the mounting assembly and the holder. The biasing member is configured to bias the holder toward the screw heads of the plurality of screws. The screws are positioned such that tightening or loosening the screws causes the position of the holder to move relative to the mounting assembly.

In a further embodiment, the display attached to the holder is a micro pixel display.

In yet another embodiment, the mounting system assembly is installed in a riflescope.

In one embodiment, the biasing member of the mounting system is a spring.

### BRIEF DESCRIPTION OF THE DRAWINGS

FIG. 1 is a schematic perspective section view of a view-through optic including one embodiment of a relay optic in accordance with the principles of this disclosure;

FIG. 2 is a schematic view of one embodiment of a relay optic in accordance with the principles of this disclosure;

FIG. 3 is a schematic view of one embodiment of a relay optic including a beam combiner in accordance with the principles of this disclosure;

FIG. 4 is a legend showing symbols used in FIGS. 5-7;

FIG. 5 is a schematic view of existing embodiments of traditional relay optic designs;

FIG. 6 is a schematic view of some of the existing embodiments of traditional relay optic designs of FIG. 5 and a schematic view of embodiments of relay optic designs in accordance with the principles of the present disclosure;

FIG. 7 is a schematic view of some of the existing embodiments of traditional relay optic designs of FIG. 5 and a schematic view of embodiments of relay optic designs in accordance with the principles of the present disclosure;

FIG. 8 is a schematic view of one embodiment of a relay optic prism in accordance with the principles of this disclosure;

FIG. 9 is another schematic view of the relay optic prism of FIG. 8;

FIG. 10 is another schematic view of the relay optic prism of FIG. 8;

FIG. 11 is a schematic view of a full optical model of information being relayed into a second focal plane of a riflescope using the replay optic prism of FIG. 8;

FIG. 12 is a schematic perspective section view of one embodiment of a mounting system for a display in accordance with the principles of this disclosure, shown installed in a riflescope;

FIG. 13 is a perspective view of the mounting system of FIG. 12, shown attached to a mounting assembly;

FIG. 14 is a detail view of the mounting system of FIG. 12, showing how the yaw of the mounting system can be adjusted;

FIG. 15 is another detail view of the mounting system of FIG. 12, showing how the pitch of the mounting system can be adjusted; and

FIG. 16 is another detail view of the mounting system of FIG. 12, showing how the vertical position of the mounting system can be adjusted.

It is to be understood that the disclosure is not limited in its application to the details of construction and the arrangement of the components set forth in the following description or illustrated in the drawings. The technology of this present disclosure is capable of other embodiments or being practiced or carried out in various ways. Also, it is to be understood that the phraseology and terminology employed herein is for the purpose of description and should not be regarded as limiting.

### DETAILED DESCRIPTION

The disclosure relates to an optical system for a viewing optic. Certain preferred and illustrative embodiments of the invention are described below. The present invention is not limited to these embodiments.

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone weapons sight, front-mount or rear-mount clip-on weapons sight, and other permutations of filed deployed optical weapons sights. Further, it will be appreciated by those skilled in the art that various combinations of features and capabilities may be incorporated into add-on modules for retrofitting existing fixed or variable weapons sights of any variety.

It will be understood that when an element or layer is referred to as being “on,” “connected to” or “coupled to” another element or layer, it can be directly on, connected or coupled to the other element or layer. Alternatively, intervening elements or layers may be present. In contrast, when an element is referred to as being “directly on,” “directly connected to” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc. may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section without departing from the disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

### DEFINITIONS

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, a “display” comprises image-creating pixel modulation. In one embodiment, the display is an emissive display. Emissive displays, including but not limited to Organic light-emitting diodes (OLED) and Light-Emitting Diodes (LED), feature the image and light source in a single device, and therefore an external light source is not required. This minimizes system size and power consumption, while providing exceptional contrast and color space. OLEDs are made from ultra-thin organic semiconducting layers, which light up when they are connected to voltage (charge carriers become injected and luminance mainly is proportional to the forward current). The major layers comprise several organic materials in sequence (for example, charge transport, blocking and emission layers—each with a thickness of several nanometers), which are inserted between an anode and a cathode. The terms “display,” “digital display,” “active display” and “microdisplay” are used interchangeably.

As used herein, “ballistics” is a way to precisely calculate the trajectory of a bullet based on a host of factors.

As used herein, an “erector sleeve” is a protrusion from the erector lens mount which engages a slot in the erector tube and/or cam tube or which serves an analogous purpose. This could be integral to the mount or detachable.

As used herein, an “erector tube” is any structure or device having an opening to receive an erector lens mount.

As used herein, the term “firearm” refers to any device that propels an object or projectile, for example, in a controllable flat fire, line of sight, or line of departure, for example, hand-guns, pistols, rifles, shotgun slug guns, muzzleloader rifles, single shot rifles, semi-automatic rifles and fully automatic rifles of any caliber direction through any media. As used herein, the term “firearm” also refers to a remote, servo-controlled firearm wherein the firearm has auto-sensing of both position and directional barrel orientation. The shooter is able to position the firearm in one location and move to a second location for target image acquisition and aiming. As used herein, the term “firearm” also refers to chain guns, belt-feed guns, machine guns, and Gattling guns. As used herein, the term firearm also refers to high elevation, and over-the-horizon, projectile propulsion devices, for example, artillery, mortars, canons, tank canons or rail guns of any caliber.

As used herein, the term “lens” refers to an object by means of which light rays, thermal, sonar, infrared, ultraviolet, microwave or radiation of another wavelength is focused or otherwise projected to form an image. It is well known in the art to make lenses from either a single piece of glass or other optical material (such as transparent plastic) which has been conventionally ground and polished to focus light, or from two or more pieces of such material mounted together, for example, with optically transparent adhesive and the like to focus light. Accordingly, the term “lens” as used herein is intended to cover a lens constructed from a single piece of optical glass or other material, or multiple pieces of optical glass or other material (for example, an achromatic lens), or from more than one piece mounted together to focus light, or from other material capable of focusing light. Any lens technology now known or later developed finds use with the present invention. For example, any lens based on digital, hydrostatic, ionic, electronic, magnetic energy fields, component, composite, plasma, adoptive lens, or other related technologies may be used. Additionally, moveable or adjustable lenses may be used. As will be understood by one having skill in the art, when the scope is mounted to, for example, a gun, rifle or weapon, the objective lens (that is, the lens furthest from the shooter's eye) faces the target, and the ocular lens (that is, the lens closest to the shooter's eye) faces the shooter's eye.

As used herein, a “reticle,” in one embodiment, is an aiming pattern for a viewing optic, such as, but not limited to, a crosshair aiming point or other aiming pattern.

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”

As used herein, the term “outward scene” refers to a real-world scene, including but not limited to a target.

As used herein, the term “shooter” applies to either the operator making the shot or an individual observing the shot in collaboration with the operator making the shot.

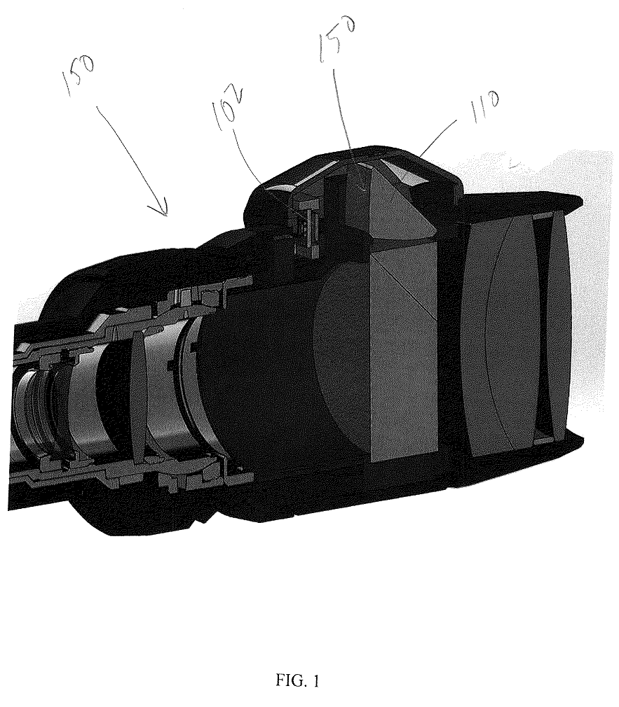

Turning now to FIG. 1, one embodiment of a relay optic 100 in accordance with the principles of this disclosure is shown incorporated into a view-through optic 150. In one embodiment, relay optic 100 can be used in a first focal plane, located proximate the objective lens system, of a viewing optic or in a second focal plane, located proximate the ocular lens system of a viewing optic. The first focal plane is located between the objective lens system and the erector lens system.

In one embodiment, the disclosure relates to a viewing optic comprising a beam combiner located between the erector lens system and the ocular lens system, and a display configured to project information to the beam combiner, wherein the beam combiner provides beam control and at least one of aberration control and magnification.

In one embodiment, the disclosure relates to a viewing optic comprising a beam combiner located between the erector lens system and the ocular lens system, a prism located above the beam combiner relative to the optical viewing axis (as one views through the ocular lenses) and a display configured to project information to the beam combiner. In one embodiment, the prism provides beam control and at least one of aberration control and magnification.

In certain embodiments, relay optic 100 can be used to efficiently overlay information into the field of view of any viewing optic. Relay optic 100 allows for the overlay of high-resolution images into the field of view in a small, manufacturable solution. Examples of information that could be displayed include, but are not limited to, a range card for a riflescope, a round count or aiming point for a reflex sight, or a live compass for binoculars or a spotting scope. Ultimately the possibilities are endless because the principles of this disclosure support a full display which can project anything the user needs onto the field of view of a view-through optic. As such, there are a wide variety of applications that can benefit from displaying information in the field of view of a view-through optic.

Relay optic 100 can be utilized to incorporate a display 102 into any suitable optic, including riflescopes. Relay optic 100 allows information to be presented to a user within the field of view of the optic 150. As shown, relay optic 100 includes a prism element 110 that directs light produced by display 102 into the field of view of the optic 150. Relay optic 100 allows the information shown on by the display 102 to be comfortably viewed regardless of position in the optical field of view.

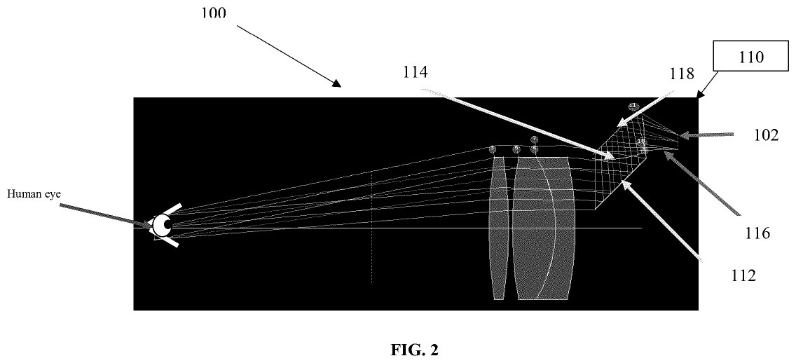

This disclosure relates to any relay optical design that includes at least one element that integrates directional beam control with one or both of aberration control and magnification. In the relay optic 100 shown in FIG. 2, a prism element 110 precedes a beam combiner 112. Prism element 110 in combination with beam combiner 112 integrates magnification (refractive surface 114, 116) and aberration control (refractive surface 114, 116) with beam control (reflective surface 118). As shown, the relay optic of FIG. 2 is for a riflescope view-through optic 150 where the information is relayed into a second focal plane.

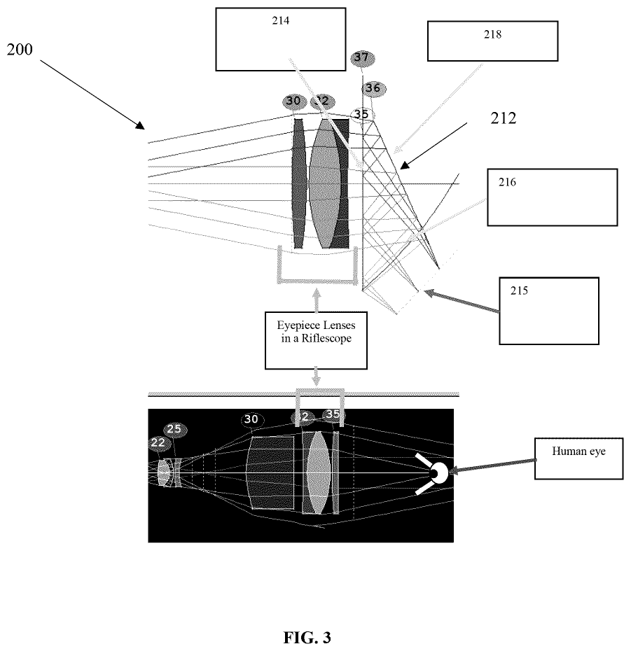

The embodiment shown in FIG. 3 has a relay optical design 200 including a beam combiner 212 that integrates all three optical functions—magnification (reflective and refractive surface 214 and refractive surface 216), beam control (reflective and refractive surface 214 and reflective surface 218), and aberration control (refractive surface 216)—into one element. In certain embodiments, relay optical design 200 could also be used in the first focal plane. Relay optical design 200 could also be used in any view-through optic to relay information to the optical path, e.g., binoculars, spotting scope, rangefinder, reflex sight, etc. In any of the aforementioned situations, a relay optical design in accordance with the principles of this disclosure would improve the optical quality of the information displayed, while also reducing the overall size of the optic.

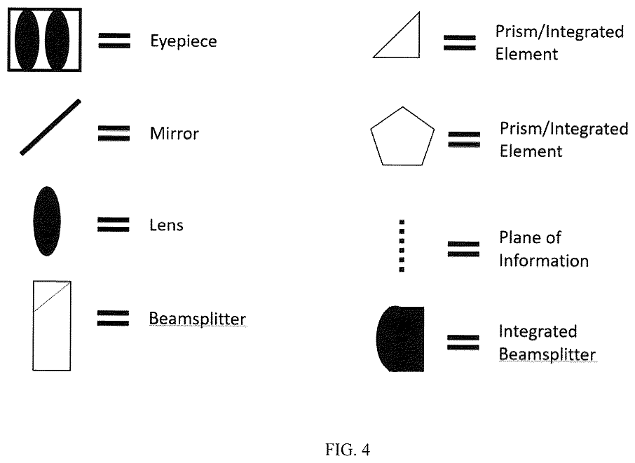

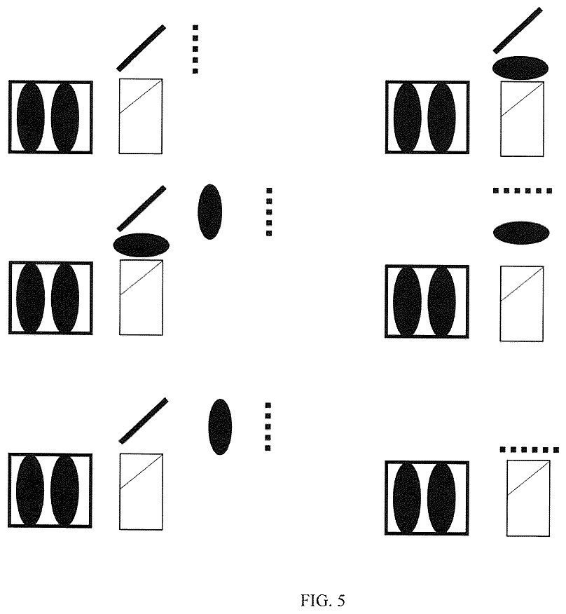

FIG. 4 contains a legend of various elements used in FIGS. 5-7. For illustration purposes, the prism elements are shown with flat surfaces for simplicity, but they may have optical surfaces that are powered for optical aberration correction or magnification, as desired.

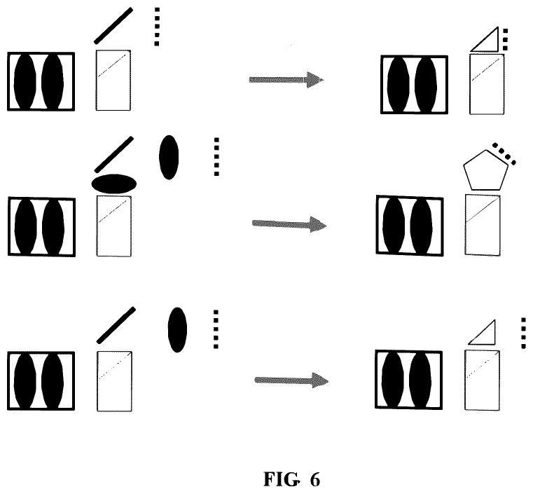

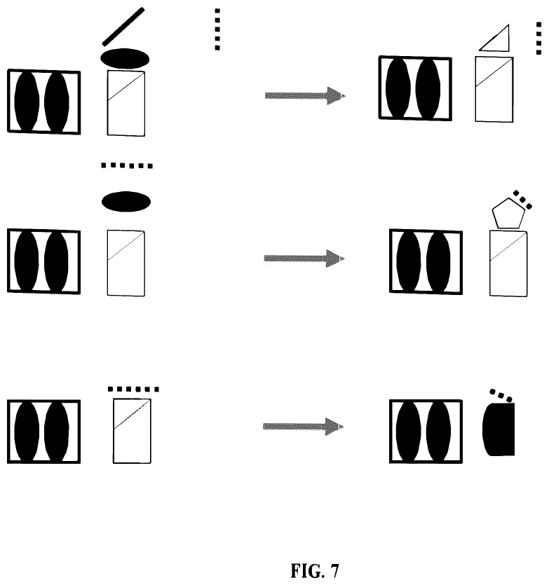

FIG. 5 shows traditional relay optical design forms for a riflescope in the second focal plane. Subsequent examples of the embodiments of this disclosure over traditional designs are given by relaying information into the second focal plane of a riflescope behind the eyepiece (FIGS. 6-7). The representative designs described in FIGS. 6-7 hold true regardless of the focal plane or type of view-through the optic. The designs result in a lighter, smaller design that can make easier use of aspheric/freeform surfaces for better correction. This design process is superior to known processes because—all else being equal for an optical design—it reduces size and allows for better optical aberration correction. Reducing the number of elements by integrating multiple functions together reduces the cost of materials and requires less assembly which reduces labor costs.

Certain existing embodiments of information displays for optics do not include a beam combiner and instead have a reflective only mirror in the view-through optic's field of view. This configuration obscures the field of view of the optic. For the examples shown of the problem being solved, it is possible to substitute a mirror for the beam combiner and all the principles of the present disclosure hold true. Although a mirror is not technically a beam combiner, it could be thought of as a 100% reflective beam combiner for the purposes of this disclosure.

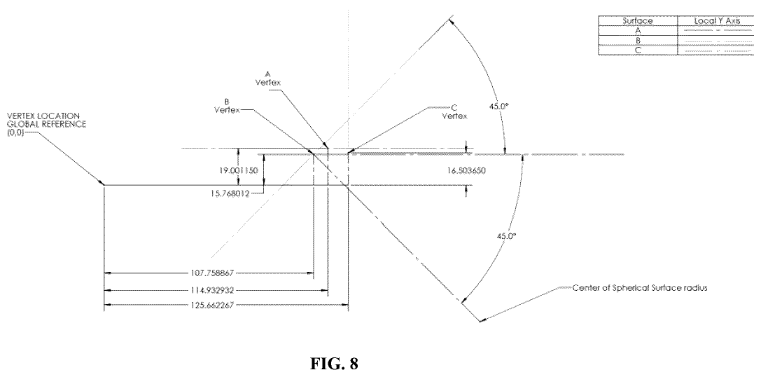

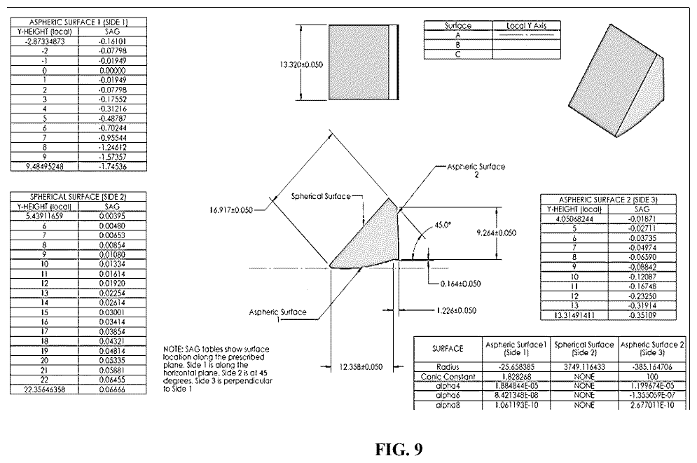

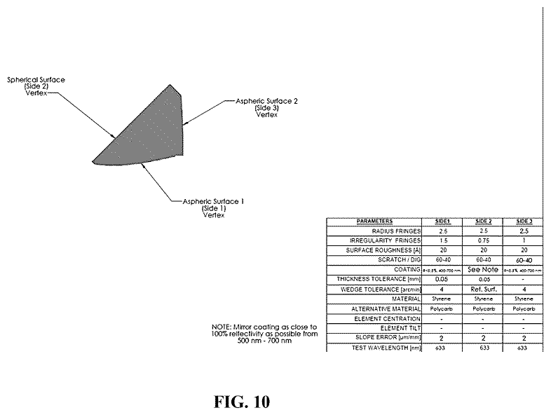

In certain embodiments, prism 110 includes beam control to reduce the number of total optical elements required for the relay optical design. FIGS. 8-10 show one example of prism 110, which includes 3 optical surfaces, though it is possible to use a prism with more surfaces, including but not limited to 4, 5, 6, 7, 8, or more than 8 optical surfaces, as long as the same principles of this disclosure are followed. Depending on the complexity and requirements of the specific design, more elements may need to be functionally combined to reduce the overall number of optical elements. In certain additional embodiments, a five-surface element/prism could be used without departing from the principles of this disclosure.

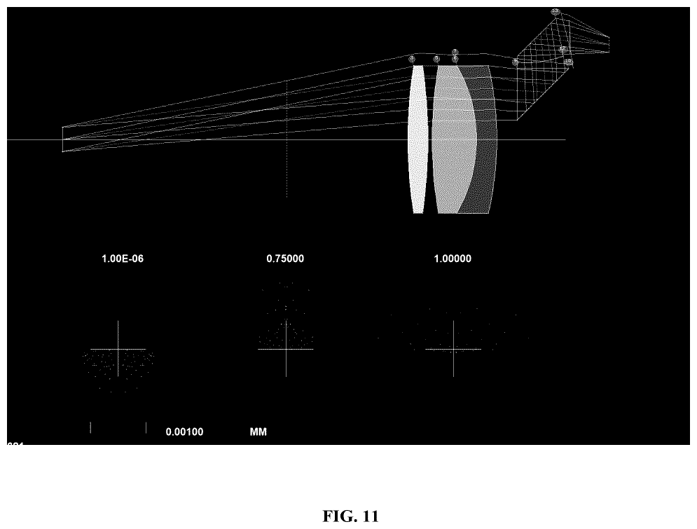

FIG. 11 shows the full optical model including the view-through optic eyepiece assembly. What would have been a design with at least two optical elements (one mirror and lens) becomes one optical element, decreasing the overall size and complexity of the design. Additionally, using an element of this form can utilize the benefits of the glass or plastic molding process, allowing the optical surfaces to be aspheric/freeform with little consequence. As a result, arms spot size of less than 1 micron may be achieved out to the full field of the information. Overall, the solution using an optical element that integrates beam control with aberration correction and magnification has resulted in a smaller, lighter weight, easier to manufacture, and high-resolution relay optical design.

### Display

In one embodiment, the viewing optic has a display. In one embodiment, the display is controlled by a microcontroller or computer. In one embodiment, the display is controlled by a microcontroller with an integrated graphics controller to output video signals to the display. In one embodiment, information can be sent wirelessly or via a physical connection into the viewing optic via a cable port. In still another embodiment, numerous input sources can be input to the microcontroller and displayed on the display.

In one embodiment, the display can be a reflective, transmissive or an emissive micro-display including but not limited to a micro display, transmissive active matrix LCD display (AMLCD), Organic light-emitting diode (OLED) display, Light-Emitting Diode (LED) display, e-ink display, a plasma display, a segment display, an electroluminescent display, a surface-conduction electron-emitter display, a quantum dot display, etc.

In one embodiment, the LED array is a micro-pixelated LED array, and the LED elements are micro-pixelated LEDs (also referred to as micro-LEDs or μLEDs in the description) having a small pixel size generally less than 75 μm. In some embodiments, the LED elements may each have a pixel size ranging from approximately 8 μm to approximately 25 μm and have a pixel pitch (both vertically and horizontally on the micro-LED array) ranging from approximately 10 μm to approximately 30 μm. In one embodiment, the micro-LED elements have a uniform pixel size of approximately 14 μm (e.g., all micro-LED elements are the same size within a small tolerance) and are arranged in the micro-LED array with a uniform pixel pitch of approximately 25 μm. In some embodiments, the LED elements may each have a pixel size of 25 μm or less and a pixel pitch of approximately 30 μm or less.

In some embodiments, the micro-LEDs may be inorganic and based on gallium nitride light emitting diodes (GaN LEDs). The micro-LED arrays (comprising numerous μLEDs arranged in a grid or other array) may provide a high-density, emissive micro-display that is not based on external switching or filtering systems. In some embodiments, the GaN-based, micro-LED array may be grown on, bonded on, or otherwise formed on a transparent sapphire substrate.

In one embodiment, the sapphire substrate is textured, etched, or otherwise patterned to increase the internal quantum efficiency and light extraction efficiency (i.e., to extract more light from the surface of the micro-LEDs) of the micro-LEDs. In other embodiments, silver nanoparticles may be deposited/dispersed on the patterned sapphire substrate to coat the substrate prior to bonding the micro-LEDs to further improve the light efficiency and output power of the GaN-based micro-LEDs and of the micro-LED array.

In one embodiment, the display can be monochrome or can provide full color, and in some embodiments, can provide multi-color. In other embodiments, other suitable designs or types of displays can be employed. The display can be driven by electronics. In one embodiment, the electronics can provide display functions, or can receive such functions from another device in communication therewith.

In one embodiment, the display can be part of a backlight/display assembly, module or arrangement, having a backlight assembly including a backlight illumination or light source, device, apparatus or member, such as an LED backlight for illuminating the display with light. In some embodiments, the backlight source can be a large area LED and can include a first or an integrated lens for collecting and directing generated light to a second, illumination or condenser lens, for collecting, concentrating and directing the light onto display, along display optical axis B, with good spatial and angular uniformity. The backlight assembly and the display are able to provide images with sufficient high brightness luminance to be simultaneously viewed with a very high brightness real world view through optics, while being at low power.

The backlight color can be selected to be any monochrome color or can be white to support a full color microdisplay. Other backlight design elements can be included, such as other light sources, waveguides, diffusers, micro-optics, polarizers, birefringent components, optical coatings and reflectors for optimizing performance of the backlight, and which are compatible with the overall size requirements of the display, and the luminance, power and contrast needs.

Representative examples of displays that can be used include but are not limited to: Microoled, including MDP01 (series) DPYM, MDP02, and MDP05; Emagin such as the SVGA, micro-displays with pixel pitches are 9.9×9.9 micron and 7.8×7.8 micron, and Lightning Oled Microdisplay, such as those produced by Kopin Corporation. Micro LED displays can also be used including but not limited to those produced by VueReal and Lumiode.

In one embodiment, the electronics working with the display can include the ability to generate display symbols, format output for the display, and include battery information, power conditioning circuitry, video interface, serial interface and control features. Other features can be included for additional or different functionality of the display overlay unit. The electronics can provide display functions or can receive such functions from another device in communication therewith.

In one embodiment, the display can generate images including but not limited to text, alpha-numeric, graphics, symbols, and/or video imagery, icons, etc., including active target reticles, ballistic information, range measurements and wind information, GPS and compass information, firearm inclination information, target finding, recognition and identification (ID) information, and/or external sensor information (sensor video and/or graphics), or images for situational awareness, for viewing through the eyepiece along with the images of the view seen through optics. The direct viewing optics can include or maintain an etched reticle and bore sight and retain high resolution.

In one embodiment, the utilization of a display allows for a programmable electronic aiming point to be displayed at any location in the field of view. This location could be determined by the user (as in the case of a rifle that fires both supersonic and subsonic ammo and thus has two different trajectories and “zeros”) or could be calculated based upon information received from a ballistic calculator. This would provide a “drop compensated” aiming point for long range shooting that could be updated on a shot-to-shot interval.

In one embodiment, the display can be oriented to achieve maximum vertical compensation. In one embodiment, the display is positioned to be taller than it is wide.

In one embodiment, the viewing optic further comprises a processor in electronic communication with the display.

In another embodiment, the viewing optic may include memory, at least one sensor, and/or an electronic communication device in electronic communication with the processor.

### Beam Combiner

In one embodiment, the relay optic has a beam combiner. In one embodiment, the beam combiner is one or more prismatic lenses (the prismatic lenses constitute the beam combiner). In another embodiment, the beam combiner combines images generated from a display with images generated from the viewing optics along the viewing optical axis of the viewing optic.

In one embodiment, a beam combiner is used to combine a generated image from a microdisplay with an image from an optical system for viewing an outward image, wherein the optical system is located in a main body of a viewing optic.

In one embodiment, a beam combiner can be aligned with the display along the display optical axis, and positioned along the viewing optical axis of the viewing optics of the main body of a riflescope, thereby allowing for the images from the microdisplay to be directed onto the viewing optical axis for combining with the field of view of the viewing optics in an overlaid manner.

In another embodiment, the beam combiner is approximately 150 mm distance from the objective assembly. In one embodiment the beam combiner is positioned at a distance from the objective assembly including but not limited to from 100 mm to 200 mm or from 125 mm to 200 mm or from 150 mm to 200 mm or from 175 mm to 200 mm.

In one embodiment the beam combiner is positioned at a distance from the objective assembly including but not limited to from 100 mm to 175 mm or from 100 mm to 150 mm or from 100 mm to 125 mm.

In one embodiment the beam combiner is positioned at a distance from the objective assembly including but not limited to from 135 mm to 165 mm or from 135 mm to 160 mm or from 135 mm to 155 mm or from 135 mm to 150 mm or from 135 mm to 145 mm or from 135 mm to 140 mm.

In one embodiment the beam combiner is positioned at a distance from the objective assembly including but not limited to from 140 mm to 165 mm or from 145 mm to 165 mm or from 150 mm to 165 mm or from 155 mm to 165 mm or from 160 mm to 165 mm.

In one embodiment the beam combiner is positioned at a distance from the objective assembly including but not limited to at least 140 mm or at least 145 mm or at least 150 mm or at least 155 mm.

In one embodiment, the beam combiner can have a partially reflecting coating or surface that reflects and redirects the output or at least a portion of the display output from the microdisplay onto the viewing axis to the viewer's eye at eyepiece while still providing good transmissive see-through qualities for the direct viewing optics path.

In one embodiment, the beam combiner can be a cube made of optical material, such as optical glass or plastic materials with a partially reflective coating. The coating can be a uniform and neutral color reflective coating, or can be tailored with polarizing, spectrally selective or patterned coatings to optimize both the transmission and reflection properties in the eyepiece. The polarization and/or color of the coating can be matched to the display. This can optimize reflectance and efficiency of the display optical path with minimal impact to the direct viewing optics transmission path.

In some embodiments, the beam combiner can have different optical path lengths for, and the direct viewing optics along viewing optical axis A. In some embodiments, the beam combiner can be of a plate form, where a thin reflective/transmissive plate can be inserted in the direct viewing optics path across the optical axis A.

### Collector Lens System

In one embodiment, viewing optic can have a collector lens system to collect light from the display. In one embodiment, the viewing has an optical system based upon the use of optical lenses as a part of one or more lens cells, which include the lens itself and a lens cell body to which the lens is mounted. In one embodiment, the lens cell includes a precision formed body that is generally cylindrical, or disc shaped. This body has a central aperture for mounting the lens in alignment with an optical axis of a larger optical system. The cell body can also be said to have its own alignment axis, which will ultimately be aligned with the optical axis for the larger system when the lens cell is mounted therein. In addition, the lens cell serves as a “holder” for the lens, serves as a mechanism by which the lens can be mounted to and in the larger optical system, and (finally) serves as a means by which the lens can be manipulated by and for the purposes of that system.

In one embodiment, the collector lens system comprises an inner lens cell and an outer lens cell.

### Reflective Material

In one embodiment, the viewing optic comprises a reflective material. In one embodiment, the reflective material is a mirror. In one embodiment, the viewing optic comprises one or more mirrors.

In one embodiment, the mirror is positioned at an angle from 30° to 60°, or from 30° to 55°, 30° to 50°, or from 30° to 45°, or from 30° to 40°, or from 30° to 35° relative to the emitted light of the display.

In one embodiment, the mirror is positioned at an angle from 30° to 60°, or from 35° to 60°, 40° to 60°, or from 45° to 60°, or from 50° to 60°, or from 55° to 60° relative to the emitted light of the display.

In one embodiment, the mirror is positioned at an angle of at least 40°. In one embodiment, the mirror is positioned at an angle of 45° relative to the emitted light of the display.

In one embodiment, the position of the mirror can be adjusted in relation to the beam combiner to eliminate any errors, including but not limited to parallax error.

In one embodiment, the position of the mirror can be adjusted in relation to the display to eliminate any errors, including but not limited to parallax error.

In one embodiment, the display for generating digital images are injected into the first focal plane of the main body, such that the digital image in the first focal plane is not tied to the movement of the erector tube.

In one embodiment, the display is configured to emit light in a direction that is substantially parallel to an optical axis of the viewing scope.

In one embodiment, the display is configured to emit light in a direction that is substantially perpendicular to an optical axis of the viewing scope.

In one embodiment, the mirror is oriented at an angle of approximately 45° relative to the emitted light of the display.

In one embodiment, the display and the mirror are located on a common side of the viewing optic main body.

In one embodiment, the display and the mirror are located on opposite sides of the viewing optic main body.

### Mounting System for a Display

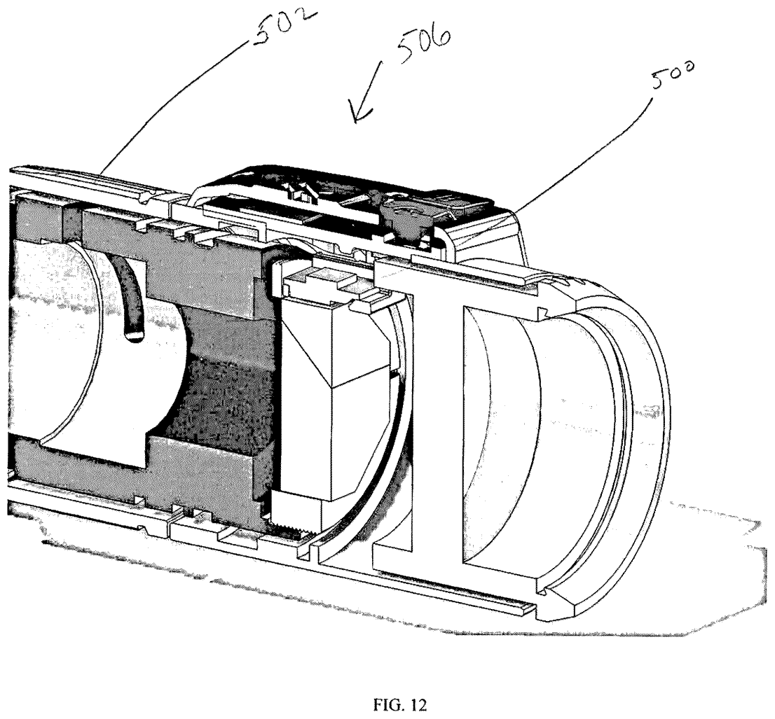

Turning now to FIGS. 12-16, one embodiment of a mounting system 500 for a display 6 is shown. Mounting system 500 includes a holder 3 that is adjustable about one or more rotational axis and one or more linear axis. In the embodiment shown, a display 6 is attached to mounting system 500, but other components including, but not limited to, a micro pixel display, emissive material (such as OLED), or any other suitable device that emits information. Mounting system 500 may position display 6 relative to a beam combiner 5, magnification lens, or other suitable optical element. Mounting system 500 is adjustable so that the image-information-produced by display 6 can be clearly and accurately represented in the optical path of a view-through optic. In certain embodiments, mounting system 500 may be used as an alternative to prism element 110 described above. In certain other embodiments, mounting system 500 may be used in conjunction with prism element 110.

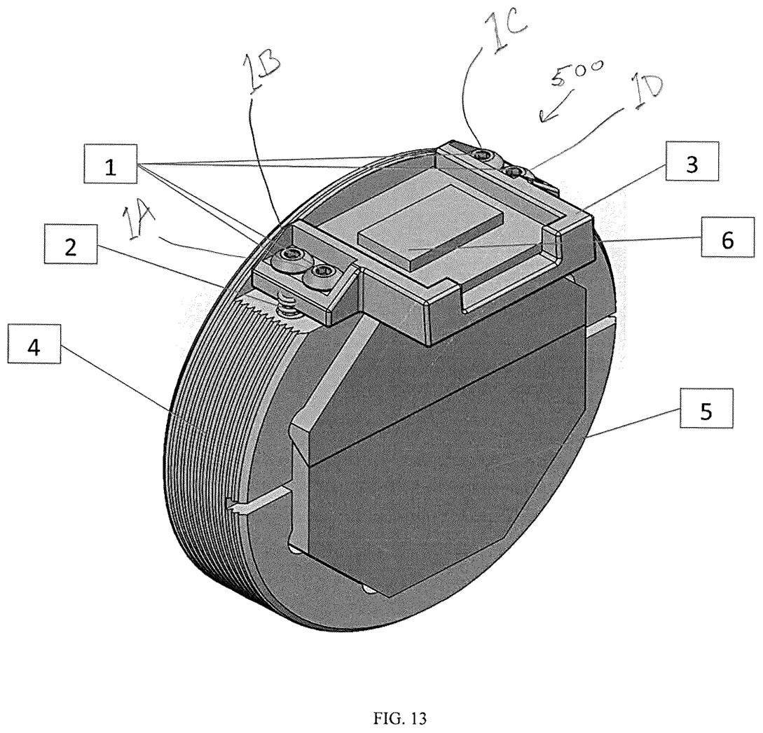

In the embodiment shown, display 6 is a micro display screen that is affixed to a riflescope 506 via adjustable members to control the alignment of the display relative to the riflescope. As shown in FIG. 13, the mounting system includes a display holder 3 for a display 6. As shown, holder 3 is made of a material suitable for mild stress, such as a polymer or metal. Of course, any suitable material or combination of materials may be used without departing from the scope of this disclosure.

Holder 3 is attached to a mounting assembly 4 containing a beam combiner 5 that mounts to the riflescope main tube 502. In the embodiment shown, holder 3 is affixed to the mounting assembly 4 via four screws 1A, 1B, 1C, 1D, each screw having a screw head, wherein the screws are positioned along sides of the holder 3. Springs 2 are used to bias the holder 3 against the screw heads. Tightening or loosening the screws 1A, 1B, 1C, 1D allows a user to adjust the position of the display 6 relative to the riflescope optical axis. Adjustable degrees of freedom for this design include, but are not limited to, vertical, roll, and pitch.

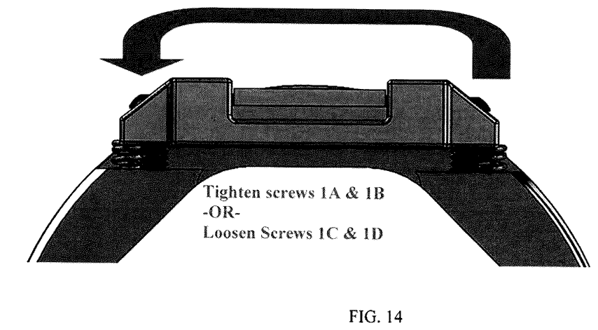

As shown in FIG. 14, tightening or loosening screws 1A, 1B, 1C, 1D on either side of holder 3 adjust the “roll” of display holder 3 in relation to the optical axis of the riflescope 506. As shown, tightening screws 1A and 1B would rotate holder 3 counter-clockwise in relation to the optical axis of the riflescope 506. Similarly, tightening screws 1C and 1D would rotate holder 3 clockwise. Loosening the screws 1 on either side of holder 3 would have the opposite effect of tightening the screws as described above.

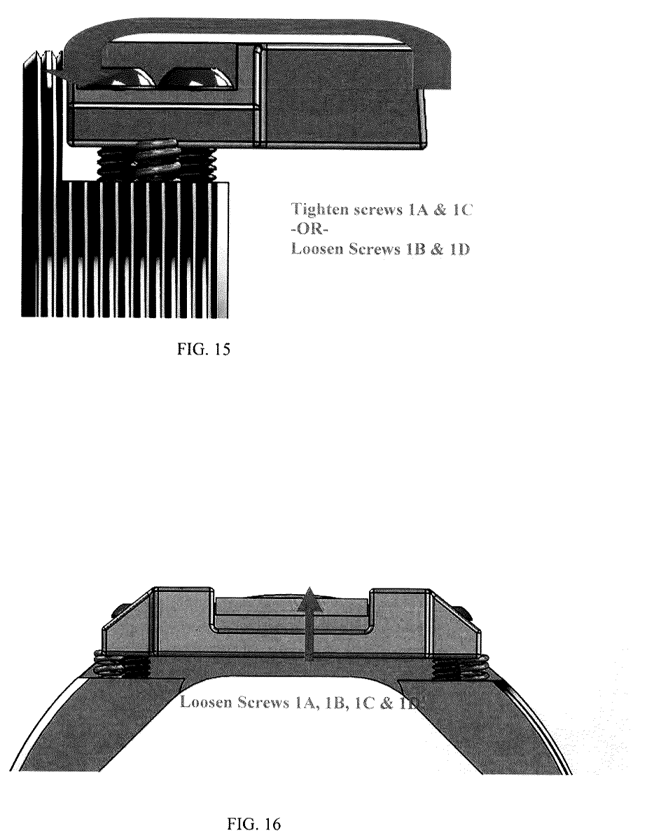

As shown in FIG. 15, tightening or loosening screws 1A, 1B, 1C, 1D can adjust the “pitch” of holder 3. As shown, tightening screws 1A and 1C would increase the pitch of holder 3 in relation to the optical axis of the riflescope 506. Similarly, tightening screws 1B and 1B would decrease the pitch of holder 3 in relation to the optical axis of the riflescope 506. In addition, Loosening screws 1A and 1C would decrease the pitch of holder 3, and loosening screws 1B and 1D would increase the pitch of the holder.

As shown in FIG. 16, tightening or loosening screws 1A, 1B, 1C, 1D can adjust the vertical position of holder 3. To adjust the vertical position of holder 3 in relation to the optical axis of riflescope 506, a user would either loosen or tighten all of the screws 1A, 1B, 1C, 1D by the same amount.

The disclosure is further explained by the following paragraphs:

A viewing optic comprising at least one optical element that integrates directional beam control with one or both of aberration control and magnification.

A viewing optic comprising at least one optical element that integrates directional beam control and aberration control.

A viewing optic comprising at least one optical element that integrates directional beam control with magnification.

A viewing optic comprising at least one optical element that integrates directional beam control, aberration control and magnification.

The viewing optic of any of the preceding paragraphs, wherein the optical element is a prism or a beam combiner.

A viewing optic comprising: a body with a first end and a second end and having a center axis; an objective lens system disposed within the body; an eyepiece lens disposed within the body; an erector lens system disposed within the body; the objective lens system, eyepiece lens, and erector lens system forming an optical system having a first focal plane, the first focal plane proximate the objective lens system and a second focal plane proximate the eyepiece; a display and a beam combiner located between the erector lens system and the second focal plane, the beam combiner configured to provide beam, aberration and magnification control.

A viewing optic comprising: a body with a first end and a second end and having a center axis; an objective lens system disposed within the body; an eyepiece lens disposed within the body; an erector lens system disposed within the body; the objective lens system, eyepiece lens, and erector lens system forming an optical system having a first focal plane, the first focal plane proximate the objective lens system and a second focal plane proximate the eyepiece; a display, a beam combiner located between the erector lens system and the second focal plane, and a prism configured to provide beam, aberration and magnification control.

A viewing optic comprising: a body with a first end and a second end and having a center axis; an objective lens system disposed within the body; an eyepiece lens disposed within the body; an erector lens system disposed within the body; the objective lens system, eyepiece lens, and erector lens system forming an optical system having a first focal plane, the first focal plane proximate the objective lens system and a second focal plane proximate the eyepiece; and a display system, the display system comprising a display positioned outside a field of view of the viewing optic; and a beam combiner having a plurality of optical surfaces, the beam combiner configured to integrate magnification, beam control, and aberration control, wherein the beam combiner causes light produced by the display to be overlayed in the field of view of the view-through optic.

The viewing optic of any of the preceding paragraphs, wherein the prism is located above the beam combiner relative to a user viewing through the ocular lenses.

The viewing optic of any of the preceding paragraphs, wherein the beam combiner includes three optical surfaces.

The viewing optic of any of the preceding paragraphs, wherein the beam combiner includes five optical surfaces.

A display system for overlaying an image in a field of view of a view-through optic, the display system comprising: a display positioned outside of the field of view of the view-through optic; a relay optic comprising: a prism element having a plurality of optical surfaces, wherein the prism element directs light produced by the display; and a beam combiner, wherein the beam combiner causes light produced by the display to be overlayed in the field of view of the view-through optic.

The display system of any of the preceding paragraphs, wherein the prism element integrates magnification, beam control, and aberration control.

The display system of any of the preceding paragraphs, wherein the prism element includes three optical surfaces.

The display system of any of the preceding paragraphs, wherein the prism element includes five optical surfaces.

The display system of any of the preceding paragraphs, wherein the display is a micro pixel display.

A mounting structure comprising a holder for a microdisplay substantially as shown and described herein.

A viewing optic comprising: a body with a first end and a second end and having a center axis; an objective lens system disposed within the body; an eyepiece lens disposed within the body; an erector lens system disposed within the body; the objective lens system, eyepiece lens, and erector lens system forming an optical system having a first focal plane, the first focal plane proximate the objective lens system and a second focal plane proximate the eyepiece; a beam combiner located between the erector lens system and the second focal plane, a prism configured to provide beam, aberration and magnification control, and a mounting assembly housing the beam combiner and having a microdisplay coupled to the top of the mounting assembly, the microdisplay configured to project a digital image to the beam combiner.

A mounting system comprising; a holder; a display attached to the holder; the holder attached to a mounting assembly by a plurality of screws, each of the screws including a screw head; at least one biasing member positioned between the mounting assembly and the holder, the at least one biasing member configured to bias the holder toward the screw heads of the plurality of screws; and the plurality of screws positioned such that tightening or loosening the screws causes the position of the holder to move relative to the mounting assembly.

The mounting system of any of the preceding paragraphs, wherein the display is a micro pixel display.

The mounting system of any of the preceding paragraphs, wherein the mounting assembly is installed in a riflescope.

The mounting system of any of the preceding paragraphs, wherein the at least one biasing member is a spring.

Although the present embodiment is installed on a riflescope, the mounting system 500 could be used with any view-through optic. In certain embodiments, the mounting system 500 can be attached to an optic via screws with springs 2 to provide bias, adjustable stand-off spacers, adjustable shims, or any other suitable adjustable fastener without departing from the principles of this disclosure. Similarly, display 6 may be mounted to the display holder 3 via adhesive, heat stakes, screws, locking cap, or any other suitable means without departing from the principles of this disclosure.

While various embodiments have been described in detail, it should be apparent that modifications and variations thereto are possible, all of which fall within the true spirit and scope of the disclosure. With respect to the above description then, it is to be realized that the optimum dimensional relationships for the parts of the disclosed technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure. Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

What is claimed is:

1. A display system for overlaying an image in a field of view of a view-through optic, the display system comprising:
a display positioned outside of the field of view of the view-through optic;
a relay optic comprising:
a prism element having a plurality of optical surfaces, wherein the prism element directs light produced by the display; and
a beam combiner, wherein the beam combiner causes light produced by the display to be overlayed in the field of view of the view-through optic.

2. The display system of claim 1, wherein the prism element integrates magnification, beam control, and aberration control.

3. The display system of claim 1, wherein the prism element includes three optical surfaces.

4. The display system of claim 1, wherein the prism element includes five optical surfaces.

5. The display system of claim 1, wherein the display is a micro pixel display.

6. A viewing optic comprising the display of claim 1.

7. A viewing optic comprising: a body with a first end and a second end and having a center axis; an objective lens system disposed within the body; an eyepiece lens system disposed within the body; an erector lens system disposed within the body; the objective lens system, eyepiece lens system, and erector lens system forming an optical system having a first focal plane, the first focal plane proximate the objective lens system and a second focal plane proximate the eyepiece; and a display system, the display system comprising:
a display positioned outside a field of view of the viewing optic; and
a beam combiner having a plurality of optical surfaces, the beam combiner configured to integrate magnification, beam control, and aberration control, wherein the beam combiner causes light produced by the display to be overlayed in the field of view of the view-through optic.

8. The viewing optic of claim 7, wherein the beam combiner includes three optical surfaces.

9. The viewing optic of claim 7, wherein the beam combiner includes five optical surfaces.

10. The viewing optic of claim 7, wherein the display is a micro pixel display.

11. The viewing optic of claim 7 further comprising a mounting system, the mounting system having a holder, wherein the display is attached to the holder, the holder attached to a mounting assembly by a plurality of screws, each of the screws including a screw head;
at least one biasing member positioned between the mounting assembly and the holder, the at least one biasing member configured to bias the holder toward the screw heads of the plurality of screws; and
the plurality of screws positioned such that tightening or loosening the screws causes the position of the holder to move relative to the mounting assembly.

12. The viewing optic of claim 11, wherein the biasing member is a spring.

13. A mounting system comprising;
a holder;
a display attached to the holder;
the holder attached to a mounting assembly by a plurality of screws, each of the screws including a screw head;
at least one biasing member positioned between the mounting assembly and the holder, the at least one biasing member configured to bias the holder toward the screw heads of the plurality of screws; and
the plurality of screws positioned such that tightening or loosening the screws causes the position of the holder to move relative to the mounting assembly.

14. The mounting system of claim 13, wherein the display is a micro pixel display.

15. The mounting system of claim 13, wherein the mounting assembly is installed in a riflescope.

16. The mounting system of claim 13, wherein the at least one biasing member is a spring.

17. A viewing optic comprising the mounting system of claim 13.
